(19) United States
(12) Patent Application Publication
(10) Pub. No.: US 2008/0162602 A1
(43) Pub. Date: Jul. 3, 2008

(54) DOCUMENT ARCHIVING SYSTEM

(75) Inventors: Ashutosh GARG, Sunnyvale, CA (US); Mayur DATAR, Santa Clara, CA (US)

Correspondence Address: HARRITY SNYDER, LLP, 11350 Random Hills Road, SUITE 600, FAIRFAX, VA, 22030, US

(73) Assignee: GOOGLE INC., Mountain View, CA (US)

(21) Appl. No.: 11/617,537

(22) Filed: Dec. 28, 2006

(51) Int. Cl. G06F 17/30

(52) U.S. Cl. 707/204

(57) ABSTRACT

A system generates a text document from a received document image. Searchable metadata elements may be assigned to all or part of the text document by a user or by a template used to generate the text document. The text document and the associated metadata elements may be stored to facilitate subsequent searching and retrieval of the text document based on contents of the text document and/or its associated metadata elements.

### BACKGROUND

1. Field of the Invention

Systems and methods described herein relate generally to information retrieval and, more particularly, to the archiving user information for subsequent searching and retrieval.

2. Description of Related Art

Modern computer networks, and in particular, the Internet, have made large bodies of information widely and easily available. Internet search engines, for instance, index many millions of web documents that are linked to the Internet. A user connected to the Internet can enter a simple search query to quickly locate web documents relevant to the search query.

In addition to publicly available documents, such as websites and other online documents, recent endeavors have been made to facilitate the indexing and storing of user documents, such as word processing documents, emails, music, etc. Applications such as Google Desktop Search, Copernic Desktop Search, and Apple Computer, Inc.'s Safari typically crawl designated portions of a user's local storage and maintain an index of searchable documents identified therein. Unfortunately, conventional document indexing tools do not provide for storage or efficient indexing of non-text based documents.

### SUMMARY

According to one aspect, a method may include receiving a document image. The document image may be converted into a text document. Searchable information may be obtained relating to the text document. At least one searchable metadata element may be associated with the text document. The text document and the at least one searchable metadata element may be stored for subsequent retrieval based on the at least one searchable metadata element.

According to another aspect a system may include a document capture system configured to capture an image of a document and a processor system. The processor system may be configured to identify text contained within the image; generate a text document based on the identified text; obtain searchable information relating to the text document; associate at least one searchable metadata element with the text document; and transmit the text document and the at least one searchable metadata element to a database via a computer network for subsequent retrieval based on the at least one searchable metadata element.

According to yet another aspect, a method may include receiving an image document; identifying text contained within the image document; generating a text document based on the identified text; obtaining searchable information relating to the text document; associating at least one searchable metadata element with the text document based on the searchable information; and storing the text document and the at least one searchable metadata element in a database for subsequent retrieval based on the at least one searchable metadata element.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram of an exemplary system 100 in which systems and methods consistent with the aspects described herein may be implemented;

FIG. 2 is an exemplary diagram of a client or server entity of FIG. 1;

FIG. 3 is a diagram of a portion of an exemplary computer-readable medium that may be used by a processing system of FIG. 1;

FIG. 4 is an exemplary diagram of an exemplary optical character recognition template; and

FIG. 5 is a flowchart of exemplary processing for capturing, processing and managing documents.

### DETAILED DESCRIPTION

The following detailed description of the invention refers to the accompanying drawings. The same reference numbers in different drawings may identify the same or similar elements. Also, the following detailed description does not limit the invention.

### Overview

More and more types of documents are becoming searchable via search engines. For example, some documents, such as personal documents, financial documents, receipts, correspondence, etc. may be scanned and their text recognized via optical character recognition (OCR). Consistent with implementations described herein, it may be beneficial to enable archiving and searching of these documents in an efficient and simple manner.

Systems and methods consistent with embodiments described herein may facilitate capturing or retrieval of documents and assignment of relevant metadata information to the documents. The documents may be OCR'd or otherwise processed to generate a textual version of the captured document. The document and its associated metadata and text version may be stored in an online repository or server, such that the document information may be easily searchable or retrievable by a number of devices based on information included in the text version and the associated metadata.

### EXEMPLARY SYSTEM

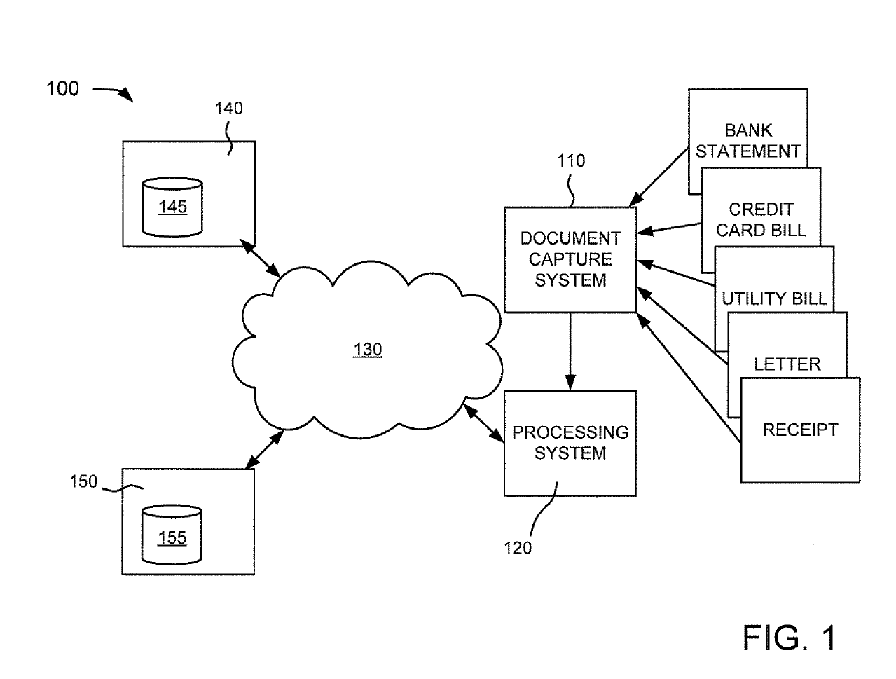

FIG. 1 is a diagram of an exemplary system 100 in which systems and methods consistent with the aspects described herein may be implemented. System 100 may include a document capture system 110, a processing system 120, a network 130, a document database server 140, and a template database server 150. In one embodiment, document capture system 110 may include a scanner or similar image capturing device configured to scan a page(s) of a document. Scanner may use conventional techniques for scanning or capturing documents. In another embodiment, document capture system 110 may be configured to retrieve and/or import digital documents that may or may not include computer-readable textual information. For example, document capture system 110 may be configured to retrieve an online bank statement from a bank web server (not shown) over network 130. Such an online bank statement may be initially retrieved in an image or non-textually-recognized electronic document format (e.g., pdf, tiff, jpeg, etc.). A “document,” as the term is used herein, is to be broadly interpreted to include any machine-readable and machine-storable work product, electronic media, print media, etc. A document may include, for example, information contained in print media (e.g., newspapers, magazines, books, encyclopedias, etc.), electronic newspapers, electronic books, electronic magazines, online encyclopedias, electronic media (e.g., image files, audio files, video files, web casts, podcasts, etc.), etc.

As described in more detail below, processing system 120 may be configured to perform OCR on documents captured or otherwise retrieved by document capture system 110 to recognize text associated with the document. Processing system 120 may include a client entity, where an entity may be defined as a device, such as a personal computer, a wireless telephone, a personal digital assistant (PDA), a laptop, or another type of computation or communication device, a thread or process running on one of these devices, and/or an object executable by one of these devices. In other aspects, processing system 120 may include a server entity that gathers, processes, searches, and/or maintains documents. In such an aspect, a “thin client” device may be configured to interact with sever-based processing system 120, where processing of documents may be performed remotely to the client device.

In one implementation, OCR processing by processing system 120 may be performed on an entirety of each captured document, with no preconfigured metadata associated therewith. In an alternative implementation, OCR processing may be based on a template or preliminary configuration that may be either automatically selected by processing system 120 or selected and/or configured by a user. Templates may assign searchable metadata to sections of documents or may instruct processing system 120 to OCR only predetermined portions of documents.

Using the bank statement example from above, a bank provided OCR template may instruct processing system 120 as to what portions of the statement relate to what kinds of information. For example, a first portion of statement documents may include account information, while a second portion may include transaction information. The template may further indicate that only the transaction information portion of the statement should be OCR'd. By providing information about a document in advance of OCR or other processing of the document, information capturing may be performed more efficiently. In one exemplary implementation, templates may be stored or otherwise maintained on a template database 155 of template database server 150 and may be accessible via network 130. In another embodiment (not shown), template database server 150 and/or template database 155 may be local to processing system 120. Additional details relating to the above-described implementations are set forth in detail below.

Document database server 140 may include a document database 145 configured to store the OCR'd text associated with a document as well as any metadata assigned to or associated with the captured document. In one implementation, an electronic copy of the captured document may be stored in document database 145 as well. As shown, in one implementation, document database server 140 may be connected to processing system 120 via network 130. However, in alternate implementations, document database server 140 and/or document database 145 may be stored locally with respect to processing system 120.

Document database server 140 may store a documents textual information and metadata information within a database record of document database 145. In one implementation, the records of document database 145 may be arranged to form a relational database, although any suitable database structure may be implemented in accordance with aspects described herein.

Network 130 may include a local area network (LAN), a wide area network (WAN), a telephone network, such as the Public Switched Telephone Network (PSTN), an intranet, the Internet, or a combination of networks. Processing system 120 and database servers 140 and 150 may connect to network 130 via wired, wireless, and/or optical connections.

### EXEMPLARY PROCESSING SYSTEM/SCANNING SYSTEM ARCHITECTURE

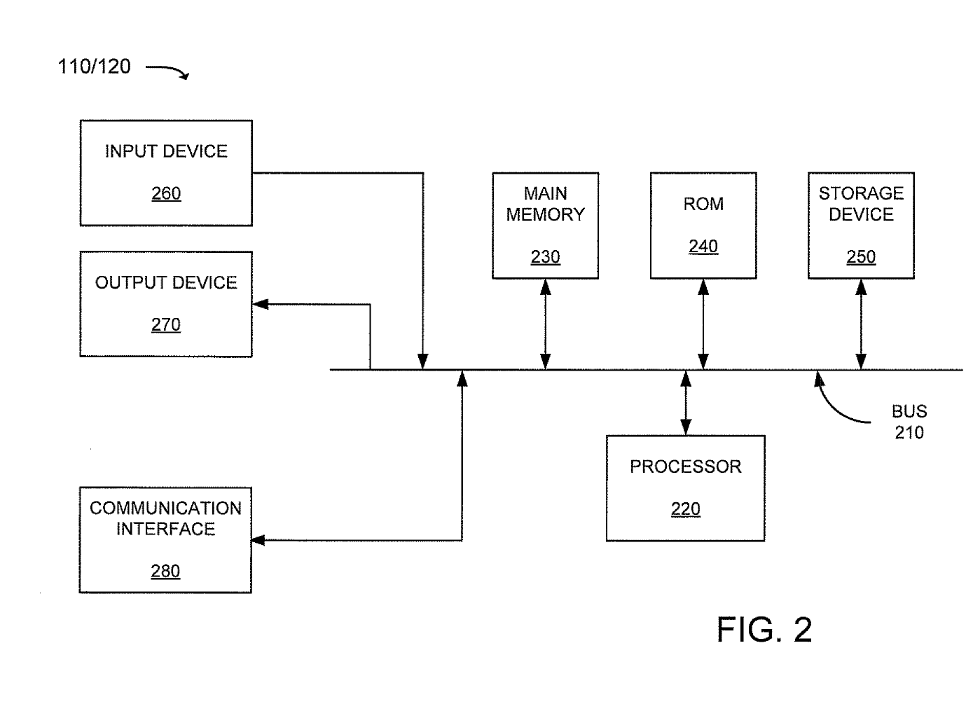

FIG. 2 is an exemplary diagram of a client or server entity (hereinafter called “system 110/120”), which may correspond to one or more of document capture system 110, processing system 120, document database server 140, and/or template database server 150. In this implementation, system 110/120 may take the form of a computer. In another implementation, system 110/120 may include a set of cooperating computers. System 110/120 may include a bus 210, a processor 220, a main memory 230, a read only memory (ROM) 240, a storage device 250, an input device 260, an output device 270, and a communication interface 280. Bus 210 may include a path that permits communication among the elements of system 110/120.

Processor 220 may include a processor, microprocessor, or processing logic that may interpret and execute instructions. Main memory 230 may include a random access memory (RAM) or another type of dynamic storage device that may store information and instructions for execution by processor 220. ROM 240 may include a ROM device or another type of static storage device that may store static information and instructions for use by processor 220. Storage device 250 may include a magnetic and/or optical recording medium and its corresponding drive.

Input device 260 may include a mechanism that permits an operator to input information to system 110/120, such as a keyboard, a mouse, a pen, voice recognition and/or biometric mechanisms, etc. Output device 270 may include a mechanism that outputs information to the operator, including a display, a printer, a speaker, etc. Communication interface 280 may include any transceiver-like mechanism that enables system 110/120 to communicate with other devices and/or systems. For example, communication interface 280 may include mechanisms for communicating with another device or system via a network, such as network 130.

As will be described in detail below, system 110/120 may perform certain document processing-related operations. System 110/120 may perform these operations in response to processor 220 executing software instructions contained in a computer-readable medium, such as memory 230. A computer-readable medium may be defined as a physical or logical memory device and/or carrier wave.

The software instructions may be read into memory 230 from another computer-readable medium, such as data storage device 250, or from another device via communication interface 280. The software instructions contained in memory 230 may cause processor 220 to perform processes that will be described later. Alternatively, hardwired circuitry may be used in place of or in combination with software instructions to implement processes in various aspects of the invention. Thus, implementations of the invention are not limited to any specific combination of hardware circuitry and software.

### EXEMPLARY COMPUTER-READABLE MEDIUM

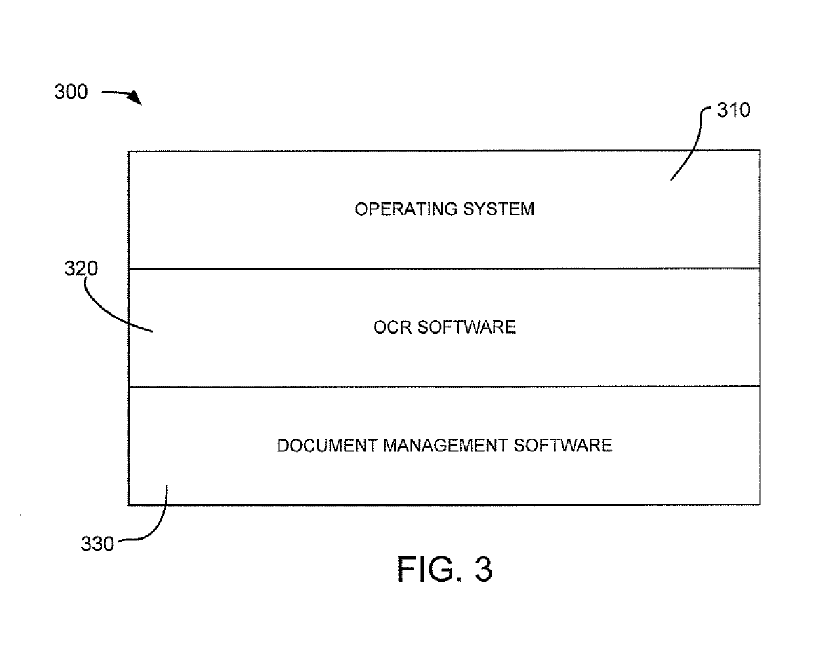

FIG. 3 is a diagram of a portion of an exemplary computer-readable medium 300 that may be used by processing system 120. In one implementation, computer-readable medium 300 may correspond to memory 230 of a client 120. The portion of computer-readable medium 300 illustrated in FIG. 3 may include an operating system 310, OCR software 320, and document management software 330.

More specifically, operating system 310 may include operating system software, such as the Microsoft Windows®, Unix, or Linux operating systems. OCR software 320 may include or use software (e.g., drivers) for interfacing with document capture system 110 to initiate capturing of document images by document capture system 110. Additionally, OCR software 320 may include software for converting an image of a captured document to a text version. As described briefly above, OCR software 320 may use a template retrieved from template database server 150 to facilitate efficient recognition of the document and assignment of metadata elements thereto.

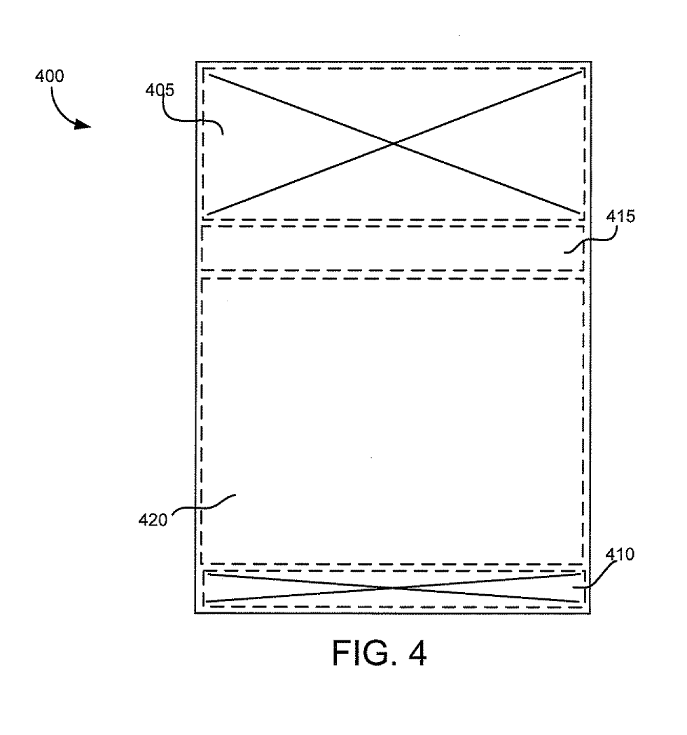

FIG. 4 an exemplary diagram of an exemplary graphical depiction of an OCR template 400 relating to the bank statement example described above. As shown, template 400 may identify several non-OCR sections 405 and 410 relating to header and footer information, which may instruct processing system 120 to not perform OCR processing on portions of the captured document relating to the locations of these sections. An account section 415 may instruct processing system 120 to assign an “account information” metadata element to any text information identified in a portion of the captured document relating to the location of section 415. Similarly, a transaction section 420 may instruct processing system 120 to assign a “transactions” metadata element to any text information identified in a portion of the captured document relating to the location of section 420. By designating OCR processing and metadata assignment for documents processed using the template, recognition and metadata assignment may be performed more efficiently than through manual implementations.

In one implementation consistent with aspects described herein, OCR software 320 may determine an OCR confidence for a converted document that indicates or otherwise determines a likelihood that a document image has been accurately converted to a text version. In one embodiment, OCR software may initiate a rescan or recapture of a document image when the OCR confidence is below a predetermined level. In one implementation, the rescan or recapture may be performed at an increased resolution. In still a further implementation, OCR confidence may be generated for each area identified in a template, with rescan or recapture only being performed when the OCR confidence for predetermined areas are below the predetermined level. Alternatively, OCR confidence thresholds for different areas of a document may be different, depending on a relative importance of the information contained therein. This eliminates unnecessary delays caused by rescanning or recapturing data from unimportant or less important areas, while maintaining highly accurate conversions for more important areas.

Document management software 330 may include software for enabling a manual review of a text version of a document(s) output by OCR software 320. Document management software 330 may provide for the correction or editing of the text version, as well as the assignment of metadata elements to one or more portions of the text version. For example, continuing with the bank statement example described above, a statement date or date range and a bank or account name may be assigned to the document. Additionally, certain portions of the document may be assigned a “debit” metadata element, while additional portions of the document may be assigned a “credit” metadata element. Document management software 330 may provide for storage of the text version, its associated metadata elements, and/or its associated document image to document database server 140 for subsequent searching and retrieval. In one implementation, document management software 330 may include an image management application such as Google® Lighthouse™ or Picasa®.

Assignment of metadata elements to a searchable text version of a document may facilitate more efficient retrieval of information contained in the document, using a combination of document data as well as one or more metadata elements. For example, a document including a particular transaction may be more easily retrieved in response to a user search for a specific payee in the text version as well as a date within the document's date range and a transaction type.

### EXEMPLARY PROCESSING

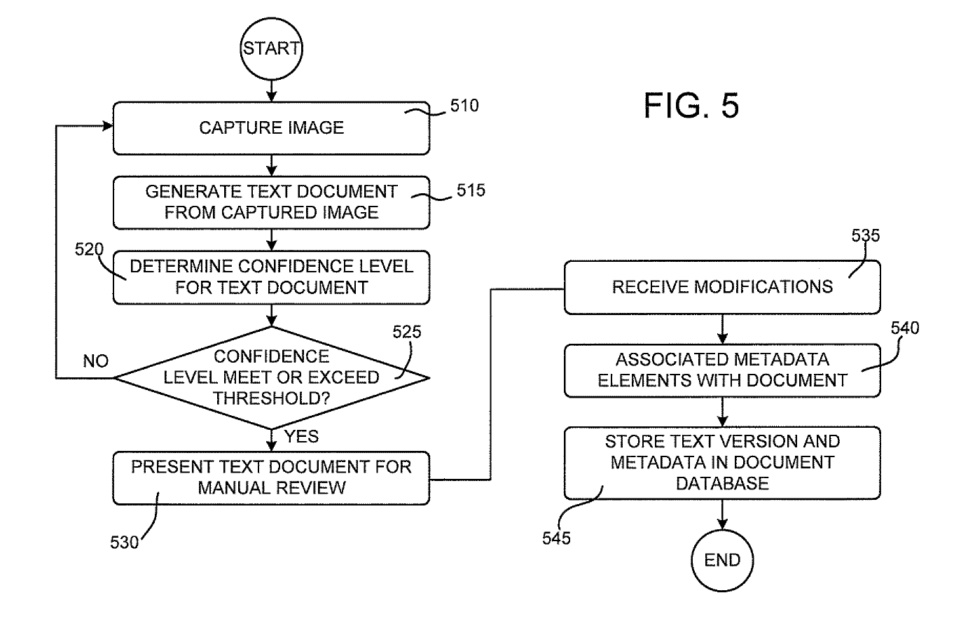

FIG. 5 is a flowchart of exemplary processing for capturing, processing and managing documents. The processing of FIG. 5 may be performed by one or more software and/or hardware components within document capture system 110 or processing system 120, or a combination thereof. In another implementation, the processing may be performed by one or more software and/or hardware components within another device or a group of devices separate from or including document capture system 110 and/or processing system 120.

Processing may begin with the document capture system 110 capturing one or more images representing a document (act 510). As described above, one implementation may use conventional scanning techniques to capture images of the pages of the document. Alternatively, document images may be retrieved or captured from an electronic source accessible either locally or from remote resources accessible via network 130.

Once captured, OCR processing may be performed on the document images to generate a textual or searchable version of the document (act 515). OCR processing may involve an analysis of an image for recognizable text and characteristics of the text (e.g., font, size, formatting, etc.) included therein as well as information regarding where the text is located on the pages based on the images of the pages of the document.

In one implementation, OCR processing may be performed on an entirety of each document image. In another implementation, OCR processing may be performed on portions of the document images based on a template retrieved from template database server 150 or, alternatively, from local storage (e.g., data storage device 250). For example, in one implementation, a bank may provide a template from a web site hosted on server 150. In another example, a user may configure or save a template for subsequent use with similar types of documents. As described above, templates may indicate various areas in a type of document and may be used to establish or assign metadata elements to those areas or to the document as a whole. In another implementation consistent with aspects described herein, a template may instruct OCR processing to performing recognition to a certain confidence level.

Once a text version of a document has been generated, a confidence level for the conversion may be determined (act 520). It may then be determined whether the confidence level meets or exceeds a predetermined threshold level indicative of an accurate conversion (act 525). If the predetermined threshold has not been met (act 525—NO), the process may return to act 510 for recapture at a same or enhanced resolution. However, if the predetermined threshold has been met (act 525—YES), the generated text version may be presented to a user for manual review and/or editing (act 530). Any changes, additions, or deletions to the text version may be received (act 535). By providing for a manual review of the generated text version, users may efficiently correct OCR errors and may remove information from the text version that is considered sensitive or confidential.

Next, one or more metadata elements may be associated with or assigned to the text version to facilitate enhanced searching and/or retrieval of the text version (act 540). As described above, information not present in the text of the document, but representative of the document content may be added as metadata elements to either the entire document, or to designated portions of the text document. For example, using the bank statement example initially presented above, metadata elements such as “bank statement”, a document date or date range, account nickname, etc. may be assigned to the text version of the document. Additionally, metadata elements may be assigned to selected portions of the text version of the document. For example, credit transactions may be assigned a “credits” metadata element, while debit transactions in the bank statement may be assigned a “debits” metadata element. In this way, information relating to the OCR'd content may be associated with the text document.

Once desired metadata elements have been assigned or, if initially assigned by a template, removed or edited, the text version and its associated metadata elements may be stored in document database 145 on document database server 140 (act 545). In one exemplary implementation, document database server 140 may be a web server configured to maintain an online storage environment for the user's OCR's documents. In other implementations, users may also store the captured images in document database 145, thereby enabling subsequent retrieval of the actual image document along with its text version.

### CONCLUSION

Systems and methods described herein may automatically identify metadata associated with a document and may create an association between the metadata and the image and/or text version of the document, making both the document content and its associated metadata available for searching and/or other processing.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

For example, while series of acts have been described with regard to FIG. 5, the order of the acts may be modified in other implementations consistent with the principles of the invention. Further, non-dependent acts may be performed in parallel.

It will be apparent that aspects of the invention, as described above, may be implemented in many different forms of software, firmware, and hardware in the implementations illustrated in the figures. The actual software code or specialized control hardware used to implement aspects consistent with the principles of the invention is not limiting of the present invention. Thus, the operation and behavior of the aspects were described without reference to the specific software code—it being understood that one would be able to design software and control hardware to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising;
receiving a document image;
converting the document image into a text document;
obtaining searchable information relating to the text document;
associating at least one searchable metadata element with the text document based on the searchable information; and
storing the text document and the at least one searchable metadata element for subsequent retrieval based on the at least one searchable metadata element.

2. The method of claim 1, wherein receiving the document image comprises capturing the document image with an optical scanner device.

3. The method of claim 1, wherein receiving the document image comprises receiving an electronic version of the document image from a storage medium.

4. The method of claim 3, wherein the storage medium is accessible via a computer network.

5. The method of claim 1, wherein converting the document image into the text document comprises:
performing optical character recognition on the document image to recognize the text of the document; and
generating the text document to include the recognized text of the document.

6. The method of claim 1, further comprising:
retrieving a template including instructions for converting portions of the document image into the text document; and
converting the document image into the text document based on the template.

7. The method of claim 6, wherein retrieving the template comprises retrieving the template from a template database accessible via a computer network.

8. The method of claim 1, further comprising:
retrieving a template including instructions for assigning the at least one searchable metadata element to at least one portion of the text document corresponding to at least one portion of the document image; and
associating the at least one searchable metadata element to the at least one portion of the text document based on the template.

9. The method of claim 1, wherein storing the text document and the at least one searchable metadata element for subsequent retrieval comprises:
storing the text document and the at least one searchable metadata element on a server accessible via a computer network.

10. The method of claim 9, further comprising:
storing the document image together with the text document and the at least one searchable metadata element.

11. The method of claim 1, further comprising:
receiving instructions to modify the text document;
modifying the text document in response to the received instructions to generate a modified text document; and
storing the modified text document and the at least one searchable metadata element for subsequent retrieval based on the at least one searchable metadata element.

12. The method of claim 11, wherein the instructions include instructions to remove at least a portion of the text document.

13. The method of claim 12, wherein the instructions include instructions to correct at least a portion of the text document.

14. The method of claim 1, comprising:
determining a confidence level indicative of an accuracy of the text document relative to the document image; and
recapturing the document image when it is determined that the confidence level is below a predetermined threshold.

15. A system, comprising:
means for receiving a document image;
means for converting the document image into a text document;
means for obtaining searchable information relating to the text document;
means for associating at least one searchable metadata element with the text document based on the searchable information; and
means for storing the text document and the at least one searchable metadata element for subsequent retrieval based on the at least one searchable metadata element.

16. A system, comprising:
a document capture system configured to capture an image of a document; and
a processor system configured to:
identify text contained within the image;
generate a text document based on the identified text;
obtain searchable information relating to the text document;
associate at least one searchable metadata element with the text document based on the searchable information; and
transmit the text document and the at least one searchable metadata element to a database for subsequent retrieval based on the at least one searchable metadata element.

17. The system of claim 16, wherein the document capture system comprises an optical scanner.

18. The system of claim 16, wherein the processor system is further configured to:
assign at least one initial metadata element to the text document based on a template.

19. The system of claim 18, wherein the at least one initial metadata element is associated with an entirety of the text document.

20. The system of claim 18, wherein the at least one initial metadata element is associated with a portion of the text document identified in the template.

21. A method, comprising:
receiving an image document;
identifying text contained within the image document;
generating a text document based on the identified text;
obtaining searchable information relating to the text document;
associating at least one searchable metadata element with the text document based on the searchable information; and
storing the text document and the at least one searchable metadata element in a database for subsequent retrieval based on the at least one searchable metadata element.

22. A computer-readable medium containing computer-executable instructions, comprising:
one or more instructions for receiving a document image;
one or more instructions for converting the document image into a text document;
one or more instructions for obtaining searchable information relating to the text document;
one or more instructions for associating at least one searchable metadata element with the text document based on the searchable information; and
one or more instructions for storing the text document and the at least one searchable metadata element for subsequent retrieval based on the at least one searchable metadata element.

23. A method, comprising:
receiving a document image from a scanning device;
performing optical character recognition on the document image to generate a text document based on the document image;
receiving modifications to the text document;
generating a modified text document based on the received modifications;
identifying searchable information relating to the modified text document;
associating at least one searchable metadata element with at least one portion of the modified text document based on the searchable information; and
storing the modified text document and the at least one searchable metadata element for subsequent retrieval based on the at least one searchable metadata element.
